(19) United States
(12) Patent Application Publication
(10) Pub. No.: US 2011/0205251 A1
(43) Pub. Date: Aug. 25, 2011

(54) PASSIVE EYEWEAR STEREOSCOPIC VIEWING SYSTEM WITH FREQUENCY SELECTIVE EMITTER

(76) Inventor: David Auld, San Jose, CA (US)

(21) Appl. No.: 12/913,229

(22) Filed: Oct. 27, 2010

Related U.S. Application Data
(60) Provisional application No. 61/306,865, filed on Feb. 22, 2010.

(51) Int. Cl. G09G 5/10; G09G 5/00

(52) U.S. Cl. 345/690; 345/208

(57) ABSTRACT

An electronic display device includes a frequency selective light source configured to generate light having a first spectral range of visible light and a second spectral range of visible light. The second spectral range of visible light is distinct from the first spectral range of visible light. The device has a plurality of sequentially updatable picture elements, and at least one of the picture elements is optically aligned with the frequency selective light source such that the light generated by the frequency selective light source provides illumination to the picture element. The device further includes a display device controller coupled to the frequency selective light source, which is configured to select, in response to an update of at least one of the picture elements, one of the first spectral range of visible light and the second spectral range of visible light, to be provided by the frequency selective light source.

### CROSS-REFERENCE TO RELATED APPLICATIONS

This application claims priority under 35 U.S.C. §119(e) to U.S. Provisional Application Ser. No. 61/306,865 entitled “Passive Eyewear Stereoscopic Viewing System with Frequency Selective Emitter,” filed Feb. 22, 2010, which is incorporated herein by reference in its entirety.

### BACKGROUND OF THE INVENTION

Embodiments of the present invention relate generally to stereoscopic imaging, and more specifically, to stereoscopic video displays for use with passive eyewear.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of an exemplary system in accordance with one embodiment of the present invention;

FIG. 2 is a schematic diagram of another exemplary system in accordance with one embodiment of the present invention;

FIG. 3 is a schematic diagram of yet another exemplary system in accordance with one embodiment of the present invention;

FIG. 4 is a flow diagram of an exemplary method in accordance with one embodiment of the present invention;

FIGS. 5A and 5B depict a display device for viewing stereoscopic images in accordance with various embodiments of the present invention; and

FIG. 6 is a flow chart illustrating a method of displaying a stereoscopic image according to one embodiment of the present invention.

### DETAILED DESCRIPTION OF THE INVENTION

Embodiments of this invention are not limited in their application to the details of construction and the arrangement of components set forth in the following description or illustrated in the drawings. Embodiments of the invention are capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Embodiments of the present invention are generally directed to systems and methods for viewing stereoscopic (also referred to herein as three-dimensional or “3D”) images with passive eyewear. With the advent of home theater systems, it is appreciated that consumers may enjoy viewing 3D movies using television equipment adapted for home use. According to various embodiments of the invention, liquid crystal display (LCD) televisions, for example, are one popular type of television that may be so adapted. As used herein, “LCD” refers to the underlying screen of a display, for example, thin film transistor LCD (TFT-LCD). It should be understood, however, that various embodiments of the present disclosure may be implemented on other types of transmissive or emissive sequentially addressable displays, including, but not limited to, TFT-LCD, Organic Light Emitting Diode (OLED), devices incorporating certain microelectromechanical systems (MEMS), and the like.

Stereoscopic imaging is well known. Stereoscopic images are produced in pairs, each image of the pair representing a scene presented at slightly different angles that correspond to the angles of vision of each human eye. For displaying stereoscopic images, particularly in movie theaters, various techniques involving simultaneous or synchronous projection of left and right field of view images have been developed. In one technique, two images, one for each field of view, are either superimposed upon each other or rapidly displayed in alternating succession. The viewer wears passive 3D eyewear, consisting of left and right circularly polarized lenses (e.g., RealD Format by RealD), frequency selective lenses (Dolby® 3D), or the like. The eyewear filters the projected images to the correct eye, giving the viewer the illusion of depth in the images.

For example, one stereoscopic technique uses alternate-frame sequencing where alternating frames of a movie or video are displayed in a left-right sequential manner In the Dolby® 3D system, a narrow band frequency selective shutter on a color wheel is inserted into the optical path of the movie projector. The color wheel contains two or more narrow band optical filters that selectively transmit, for example, light having red, green, and blue (RGB) wavelengths of the visible spectrum. For example, one filter, intended for the left eye view, may pass only a first triplet of light frequencies (e.g., RGB), and another filter may pass only a second triplet of light frequencies (e.g., R′G′B′). One such technique is well known to the art and was developed by Infitec, and is licensed to Dolby® for Dolby® 3D applications. The filters are switched between RGB and R′G′B′ using the color wheel, which rotates at constant angular velocity. A mechanical shutter blocks the light from the projector when the wheel rotates across the barrier between the RGB and R′G′B′ filters.

In theatrical applications, a movie is typically projected either from film stock, or digitally using typically a MEMS array and light source (e.g., using DLP™ by Texas Instruments). Both film and MEMS (DLP) share the attribute that the entire frame is advanced from one picture to the next more or less instantaneously. Therefore, by carefully synchronizing each frame advance with the switching of the optical filter, the movie can be presented in a left-right sequential manner, which is alternately steered to the left and right eye of the viewer wearing passive eyewear having frequency selective lenses that correspond to the respective RGB and R′G′B′ frequencies of the filters (light going to the alternate eye being blocked by the frequency selective lens). This enables the viewer to perceive 3D effects of the movie without observing any visual artifacts associated with mismatches between the orientation of the filter (color wheel) and the projected 3D image. Passive eyewear is lightweight, inexpensive to manufacture, and may be made in many styles common to conventional eyewear, such as sunglasses, optical correction glasses, eye protection glasses, and contact lenses.

Techniques have also been developed for viewing 3D movies at home. In a conventional 3D LCD television, the viewer wears active eyewear having, for example, LCD pi-cell shutter lenses such as those described in Philip J. Bos et al., “The pi-Cell: A Fast Liquid-Crystal Optical-Switching Device,” Tektronix Corp., Mol. Cryst. Liq Cryst. 113 (1984), p. 329. The eyewear is coupled to the television system, and each lens is alternately switched between clear and opaque in synchronization with the frames of a movie that is displayed using the alternating field of view technique. Active eyewear, however, is heavy, expensive, and uncomfortable to wear.

According to one aspect of the invention, it is appreciated that a three-dimensional viewing system may have application for home use in conjunction with, for example, a progressive or non-interlaced scan television. Such a television includes a display having a plurality of picture elements that are sequentially updated. However, in a progressive scan television, an update of the entire image (or field of view) occurs over a non-zero time interval (e.g., about 8 ms for a 120 Hz LCD TV) because each pixel of the display is updated sequentially, rather than simultaneously. For instance, at any given time during an update of the field of view (e.g., a scan of the display), one portion of the TV screen may display the previous frame while the other, most recently updated portion, displays the current frame. In an alternate-frame sequence, this causes crosstalk between the left and right eyes because there is insufficient time available between field updates for the frequency selective shutter to switch quickly enough to match the underlying image. This may produce visual artifacts that can be disconcerting to the viewer, and also diminishes the 3D effect.

Therefore, it is desirable to produce a 3D stereoscopic TV system which avoids these and other limitations and permits use of passive eyewear.

According to one aspect of the present invention, a series of stereoscopic (3D) images are presented on an LCD display in an alternate-frame sequence. For example, the image series comprises alternating frames of left and right fields of view for generating an illusion of depth in conjunction with specialized eyewear. It should be appreciated that the alternate-frame sequence is merely one exemplary method of presenting stereoscopic images, and that other frame sequences may be used, such as left-left-right-right, and so forth. Each frame is steered to only the correct eye, which is necessary to produce a 3D effect, using the various techniques described in further detail herein.

The LCD display, in some embodiments, comprises an array of electrically operated light valves (e.g., liquid crystals) called picture elements or pixels. Each pixel typically comprises several sub-pixels each having one of the light valves and an associated wide band color filter to produce, for example, red, green, or blue light, as will be familiar to one of skill in the art. The pixels themselves do not produce any light; rather, a light source, such as a backlight unit (BLU) or an edge-light unit, provides light that is bright and uniform and is distributed to the pixels using, for example, a light guide plate (LGP) or similar device. The light source may comprise one or more light emitters, such as cold cathode fluorescent lamps (CCFLs) tubes or light emitting diodes (LEDs). The light valves in each sub-pixel are modulated to allow varying amounts of the distributed light to pass through, and that light is filtered by the sub-pixel color filters into, for example, one of the primary colors of red, green, or blue. Thus, each pixel produces a wide range of light intensities and colors resulting from the combination of the red, green, and blue light transmitted by each of the sub-pixels. A viewable image across the display is created by controlling the modulation of all sub-pixels.

According to another aspect of the invention, stereoscopic images may be displayed using an INFITECT™-based technique. INFITEC™ was developed by DaimlerChrysler AG, now Daimler AG, and commercialized by INFITEC GmbH of Germany, and is described by Helmut Jorke et al., “INFITEC—A New Stereoscopic Visualisation Tool by Wavelength Multiplex Imaging” (http://www.jumbovision.com.au/files/Infitec_White_Paper.pdf). The name “INFITEC” is derived from an “interference filter technique,” wherein image information is transmitted in different wavelength triplets of the visible spectrum of light. The human eye is sensitive to light in generally three spectral ranges that are related to the primary colors of red, green, and blue. A color display, such as found in a color television, computer monitor, or other display device, may comprise many pixels that each emit red, green, and blue light within relatively narrow bandwidths of these three spectral ranges. Since the human eye can generally perceive the same colors over a broader range of wavelengths, image information may be transmitted over one or more different narrow-band wavelength triplets of the primary colors using, for example, a wavelength multiplex display. INFITEC has been used, for example, in various theatrical applications. Accordingly, it is appreciated that the INFITEC technique may be adapted for home use applications.

According to various embodiments of the invention, stereoscopic images are transmitted to a viewer in two different wavelength triplets of light, for example, RGB and R′G′B′. Different images for the left and right eyes are displayed using the two triplets. When viewed in conjunction with passive eyewear having different frequency selective lenses that either pass or block one of the two wavelength triplets, the viewer will see only the left eye images with her left eye and only right eye images with her right eye, producing a perceived 3D effect. For example, RGB may be designated for the left eye and R′G′B′ may be designated for the right eye. In another example, RGB may be designated for the right eye and R′G′B′ may be designated for the left eye. Passive eyewear is advantageous because it is lightweight, inexpensive, and comfortable to wear.

To produce different wavelength triplets of light, according to one embodiment, two or more narrow-band optical filters are used to filter the light generated by a light source (e.g., from a BLU or other light source) of a display device. For example, one optical filter permits a first spectral range of visible light to pass through, while blocking all or substantially all other wavelengths of visible light, and another optical filter permits a second spectral range of visible light to pass through, while blocking all or substantially all other wavelengths of visible light. The optical filters may be interposed between the light source and, for example, the pixels of the display device. By selectively switching between the two optical filters in synchronization with the frames of a video, frames containing, for example, a right eye field of view may be displayed in the first spectral range of visible light (e.g., RGB), and frames containing a left eye field of view may be displayed in the second, distinct spectral range of visible light (e.g., R′G′B′). When used in conjunction with frequency selective eyewear, such as described above, the viewer sees frames with the right eye field of view with her right eye and frames with the left eye field of view with her left eye. This produces a 3D effect for the viewer.

In another embodiment, different wavelength triplets of light are produced using a plurality of LED emitters, each having frequency-selective phosphors embedded in the LED lens. The frequency of light generated by each emitter is matched to one of the selective filters in the lenses of the passive eyewear. For example, there may be two sets of emitters where one set produces RGB light and the other set produces R′G′B′ light. In normal viewing mode (2D), both sets of emitters (e.g., RGB and R′G′B′) are illuminated continuously, which produces a wide spectrum of white light that is observable by both of the viewer's eyes without the eyewear. In stereoscopic viewing mode (3D), each set of emitters is switched on and off in synchronization with the respective frames of the video. For instance, the RGB emitters may be illuminated (e.g., turned on) when a right eye field of view frame is displayed, while the R′G′B′ emitters are dimmed, blocked, shuttered, or extinguished (e.g., turned off). Furthermore, the R′G′B′ emitters may be illuminated when a left eye field of view frame is displayed, while the RGB emitters are dimmed.

In another embodiment, the light source comprises a plurality of emitters that produce various spectral ranges of visible light, for example, RGB and R′G′B′. The emitters with emission frequencies RGB and R′G′B′ are located at appropriate locations such that light of both frequencies is uniformly distributed across the picture elements of the display. For example, if all RGB emitters are turned on, then the entire display is uniformly lit with RGB light, and if all R′G′B′ emitters are turned on, then the entire display is uniformly lit with R′G′B′ light. The emitters may be arranged in clusters that are controlled independently of one another so as to produce a scanning backlight that follows or mimics the update scan of the picture elements. For example, each cluster of emitters may illuminate a substantially horizontal segment of the display. The emitters are controlled such that the emitters that illuminate the region of the display which is being updated (e.g., in a line-sequential manner) are dimmed. Therefore, the portion of the image being updated is obscured or substantially obscured from the viewer, reducing or eliminating crosstalk caused by seeing the displayed left or right frame with the wrong eye while maximizing the brightness of the light output by the display.

In one embodiment, an LCD display includes an array of picture elements, or pixels, each comprising one or more electrically operated light valves, or sub-pixels, for producing red, green, and blue light. Each sub-pixel contains a light valve and a wide band color filter, which may be deposited in the LCD pixel cell using methods known in the art. LCD screens are selectively light transmissive, and the display includes a light source such as a backlight unit (BLU) that provides bright, generally uniform, light to the pixels. The light is selectively modulated by the sub-pixel light valve (e.g., to control the amount of light passing through the pixel cell), and selectively filtered by the sub pixel color filter (e.g., into red, blue, and/or green wavelengths). By controlling the modulation of each sub-pixel, a color image can be displayed, and by displaying a sequence of images, the appearance of a moving image can be created. The backlight or other light source is typically a wide band (e.g., white) light source; and the color filters in the sub-pixels are wide band within their color range.

The light source is typically constructed using one or more high brightness light emitters, for example CCFL tubes or LEDs. According to various embodiments, the frequency of light generated by the emitters is precisely controlled to match the selective filters in the lenses of the eyewear. The light is sequenced through, for example, RGB and R′G′B′ emitting modes synchronously or substantially synchronously with the displayed frames of a video that comprise, for example, alternating left and right eye images of a 3D movie or other video program. Accordingly, an observer at the front of screen, and who is wearing the frequency selective eyewear, will perceive a stereoscopic image.

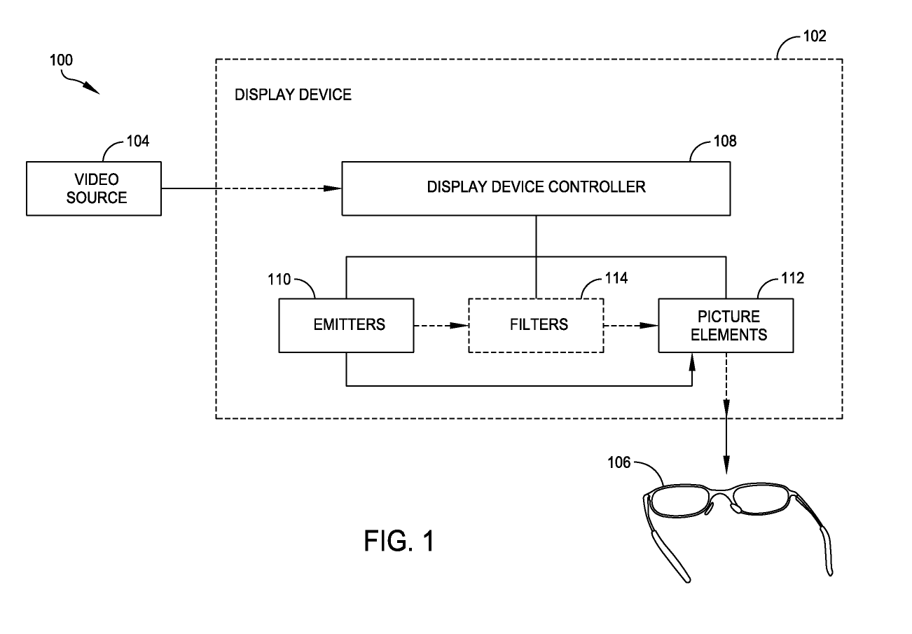

Referring to FIG. 1, a system 100 for viewing stereoscopic images in accordance with one embodiment includes a display device 102, a video source 104 that provides images to be displayed by the display device, and passive eyewear 106 to be worn by a viewer while viewing the display device. In some embodiments, the display device 102 is based at least in part on a progressive scan television, although the display device may also include additional or alternative components depending on the application. The display device 102 includes a display device controller 108 coupled to one or more emitters 110 and a plurality of picture elements 112 collectively configured to display an image. In one embodiment, display device controller 108 is further coupled to one or more optical filters 114.

According to one embodiment, display device controller 108 receives a video signal from video source 104. The video signal may include 2D and/or 3D images, and frame synchronization information. Display device controller 108 uses the video signal to update picture elements 112. Display device controller 108 may also use the synchronization information to synchronize the control of emitters 110 with each of the video fields displayed by picture elements 112 such that each frame (or portion of each frame) of the video presented, for example, in an alternate-frame sequence, is steered to the correct eye of the viewer by the frequency selective lenses of passive eyewear 106, as will be described in further detail below.

According to one embodiment, picture elements 112 are part of a sequentially addressable display screen, for example, a thin film transistor liquid crystal display (TFT LCD), an organic light emitting diode (OLED), or other microelectromechanical systems (MEMS) devices. It should be understood that the invention may also be implemented in other types of emissive, sequentially addressable displays. Picture elements 112 are updated sequentially at, for example, 120 Hz.

In one embodiment, display device 102 is an LCD television or similar display device including at least two frequency-selective light emitters 110 for producing different frequencies of light. An LCD screen comprises arrays of selectively controllable light valves, or shutters, which open and close to allow light to pass through or block light, accordingly. The light is provided by emitters 110 which may be LEDs; however, it should be appreciated that other types of emitters, for example, CCFL, OLED, FED, and SED, may also be used. Emitters 110 may be configured, for example, to back-light or edge-light picture elements 112, or in any other arrangement in which the light is transmitted from the emitters to the picture elements such as, for example, through a light guide.

A conventional white light LED is typically manufactured using a near ultraviolet emitter, covered with a lens which embeds a white phosphor. The phosphor absorbs the near-UV photon and emits one or more photons in the visual spectrum. By carefully selecting the phosphors, white light can be emitted. It is known in the art methods of producing phosphors that emit any color temperature of white or other colors of the visual spectrum. Since phosphor emission is a quantum mechanical effect, it is possible to create a phosphor that can emit light in very narrow band of frequencies, or in multiple narrow frequency bands.

In one embodiment, a light source of an LCD television includes a plurality of modified LED emitters. The conventional white phosphor of each LED emitter is replaced with a frequency selective phosphorescent material. For example, half the LEDs in the BLU are given the phosphor RGB, and half are given the phosphor R′G′B′. It should be appreciated that ratios other than half-and-half may be utilized. During normal operation (e.g., while displaying 2D images), both sets of LED emitters are illuminated resulting in a light output that is RGB combined with R′G′B′, which is wide spectrum white. The LCD can therefore be viewed in a normal manner (e.g., without specialized eyewear) and at normal brightness levels. During stereoscopic 3D operation, the LEDs are selectively switched synchronously with the frames of the video. LEDs with RGB phosphors are illuminated during display of, for example, the right eye image, and LEDs with R′G′B′ phosphors are illuminated during the display of the left eye image. Since the wide band color filters in the sub-pixel cells are purely subtractive, they cannot shift the frequency of the RGB or R′G′B′ light sources. Therefore, the frequency selective nature of the light source is preserved. A viewer, wearing the corresponding frequency selective passive eyewear, will observe the left eye images and right eye images steered to the correct eyes. Therefore, she will observe the stereoscopic 3D effect of the video. It should be noted that because RGB and R′G′B are both observed as white light, the stereoscopic video will have excellent color reproduction and stereo separation.

Referring again to FIG. 1, according to one embodiment, emitters 110 produce at least two distinct frequencies of light, for example a first spectral range of visible light (e.g., RGB) and a second spectral range of visible light (e.g., R′G′B′); however, it should be appreciated that other frequencies may be used. Eyewear 106 is configured such that one lens allows RGB light to pass through while blocking R′G′B′ light, and the other lens allows R′G′B′ light to pass through while blocking RGB light. Further, emitters 110 can be controlled such that display device 102 emits either RGB light only or R′G′B′ light only. In this manner, display device 102, in conjunction with eyewear 106, can steer displayed images to one eye of the viewer or the other, for example, on a frame-by-frame basis. Therefore, when displaying a series of images configured for 3D viewing, the viewer perceives a 3D effect.

In another embodiment, a light source, such as a BLU, comprises conventional, wide band white emitters. The emitters may be, for example, LED, CCFL, OLED, or any other emitter with sufficient color purity. The emitter is coupled with the BLU in a conventional manner, except for the addition of a switchable optical filter that is interposed between the emitter and the pixels of the display. The switchable optical filter may comprise two optical filters, for example, one allowing only RGB frequencies to pass through the filter when it is open and only R′G′B′ frequencies when it is closed. By interposing the filter between the emitter and a light guide inside the BLU, the white light emitter can be selectively filtered between RGB and R′G′B′, as required. During stereoscopic 3D operation, the filter is selectively switched synchronously with each frame of the video. The RGB filter is used, for example, during display of the right eye image, and the R′G′B′ filter is used during the display of the left eye image. It should be appreciated that left and right, as used herein, are illustrative and interchangeable. Again, because the wide band color filters in the sub-pixel cell are purely subtractive, they cannot shift the frequency of the RGB or R′G′B′ light sources, and the frequency selective nature of the light source is preserved. A viewer, wearing the corresponding frequency selective passive eyewear, will observe the left eye images and right eye images steered to the correct eyes, and observe the stereoscopic 3D effect of the video.

In one embodiment, the switchable optical filter described above is small, electronically controlled, contains no moving parts, and is inexpensive to manufacture. Since the filter needs to be located in the optical path of each emitter, it is appreciated that it is advantageous to have as few emitters as possible, such as those in an edge-lit LED BLU, although any number of emitters may be used. One such filter is described in part in U.S. Pat. No. 7,410,309 to Viinikanoj a et al., which is hereby incorporated by reference in its entirety. The filter includes two substantially transparent surfaces that are separated by a capillary space. A first fluid conditioned to filter, for example, RGB light is in contact with a second fluid conditioned to filter R′G′B′ light. The density of each of the fluids are dissimilar, preventing them from mixing. The fluids are moved through the capillary space by piezo-electric actuators, or by electrostatic force. Accordingly, when the first fluid is in the capillary space, the filter transmits a first spectral range of light (e.g., RGB), and when the second fluid is in the capillary space, the filter transmits a second spectral range of light (e.g., R′G′B′). The device may be a MEMs device, and can be manufactured at low cost.

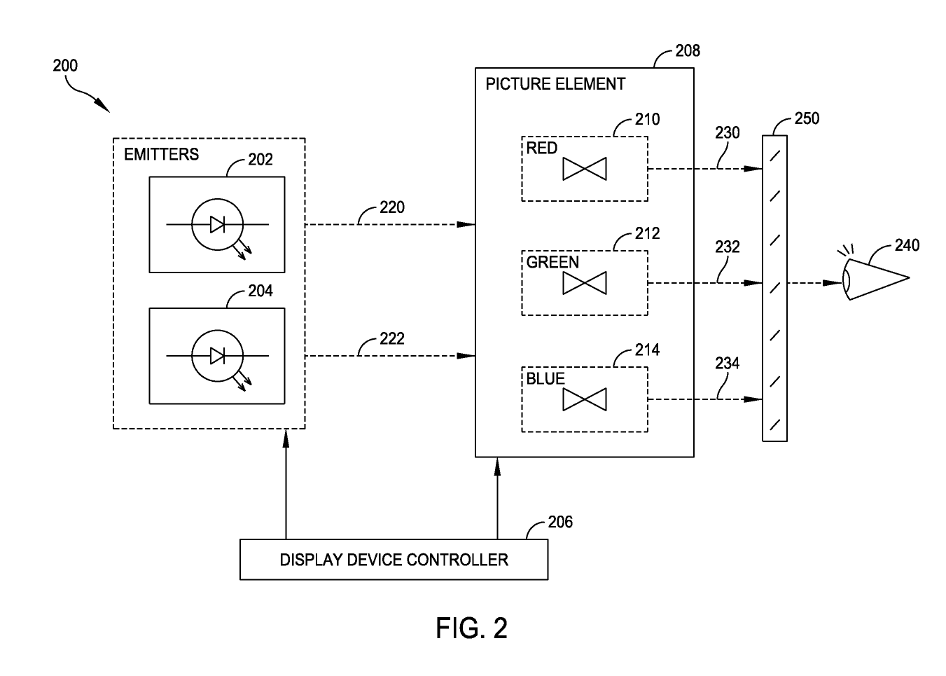

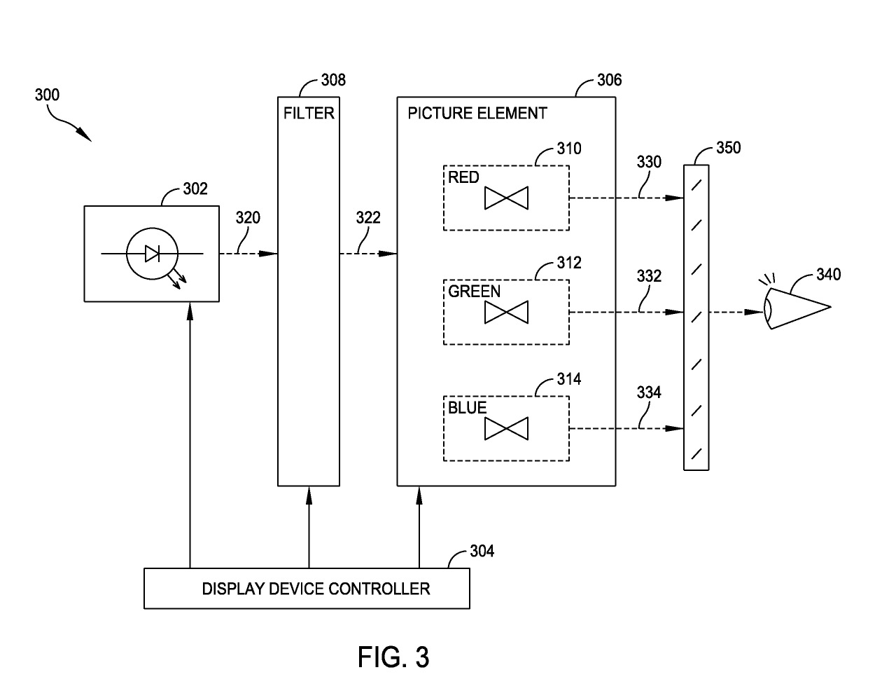

Referring now to FIG. 1, according to one embodiment, display device 102 is configured substantially as described above with respect to the frequency-selective emitters; however, emitters 110 produce a substantially white light having a wide spectrum band. Display device 102 additionally includes one or more independently controllable optical filters 114 that are coupled to display device controller 108. Filters 114 are interposed between emitters 110 and picture elements 112 such that the light emitted by the emitters is filtered by the filters before reaching the picture elements. Filters 114 may be switched such that light is filtered into one of a plurality of different frequencies, for example, RGB or R′G′B′. In other respects, display device 102 operates substantially as described above. These and other embodiments will be described in further detail below, for example, with respect to FIGS. 2 and 3.

In yet another embodiment, display device 102 includes a plurality of emitters 110 coupled to display device controller 108. Individual emitters within the plurality of emitters 110 are configured to emit light having one of at least two distinct frequency ranges, for example, RGB and R′G′B′, such as described above. At least one RGB emitter and at least one R′G′B′ emitter is further arranged into an emitter cluster that illuminates substantially only one portion of the display, for example a horizontal segment of the display. Additional independently controllable emitter clusters are similarly configured to illuminate each of other portions of the display. For instance, each horizontal segment of the display may be illuminated by an emitter cluster with RGB light, R′G′B′ light, or both (e.g., wide spectrum white light). Emitters 110 are controlled, for example, so as to create a rolling backlight effect that follows or mimics the sequential update of the display. For instance, as a first portion of the display is being updated, the corresponding emitter cluster is dimmed to obscure or substantially obscure from the viewer artifacts caused by transitions associated with updating picture elements 112 in the first portion. After the first portion of the display is updated, the emitters in the corresponding emitter cluster are illuminated. For example, if the first portion of the display is displaying an image intended for the viewer's right eye, only the RGB emitter(s) is illuminated, and if an image intended for the viewer's left eye is displaying, only the R′G′B′ emitter(s) is illuminated. Accordingly, in conjunction with eyewear 106, the viewer sees light emanating from the first portion of the display with the correct eye, helping to create a 3D effect. The dim-illuminate sequence repeats for each emitter cluster as each portion of the display is updated. In this manner, crosstalk between different fields of view (e.g., left and right) is reduced or eliminated while maximizing the brightness of the display.

FIG. 2 illustrates a schematic diagram of a display device 200 for viewing stereoscopic images in accordance with one embodiment of the present invention. Display device 200 includes an LCD display or other electronically modulated optical device that forms part of a television, computer, or other display device adapted to display images that, in conjunction with eyewear having polarized lenses, produce a stereoscopic effect for a viewer. It should be appreciated that display device 200 may comprise, for example, a thin film transistor liquid crystal display (TFT LCD), an organic light emitting diode (OLED), or other microelectromechanical systems (MEMS) device.

In one embodiment, display device 200 includes a plurality of sequentially addressable picture elements such as picture elements 112 described above with reference to FIG. 1. The picture elements, including picture element 208, may be controlled, for example, by a display device controller 206, such as display device controller 108 described above with reference to FIG. 1. Display device 200 includes at least two emitters 202, 204, a display device controller 206, and a picture element 208. Display device 200 may be configured such that light emanating from emitters 202, 204 propagates through picture element 208 and onward towards the viewer. Emitters 202, 204 may include one or more florescent lamps, one or more light emitting diodes (LEDs), such as white phosphor based LEDs, red-green-blue (RGB) LEDs, organic LEDs (OLEDs), or other electronic light sources. In one embodiment, emitters 202, 204 are arranged in a backlit configuration for illuminating picture element 208 from behind with respect to a viewer of the light emanating from display device 200. In another embodiment, emitters 202, 204 may be configured to illuminate picture element 208 indirectly, such as from a side or edge of the display.

In an embodiment, emitter 202 is configured to emit a first spectral range of visible light 220 (e.g., RGB), and emitter 202 is configured to emit a second spectral range of visible light 222 (e.g., R′G′B′) that is different than the first spectral range of visible light. Each emitter is controllable by display device controller 206 such that emitter 202 may be illuminated and dimmed independently from emitter 204. Light emitted from emitters 202, 204 is transmitted to picture element 208, which includes a plurality of light valves 210, 212, 214. The light valves may include, for example, a wide band color filter for red 210, green 212, and blue light 214. Light valves 210, 212, 214 may be coupled to display device controller 206 for modulating the amount and color of light passing through picture element 208. Accordingly, depending on the modulation of light valves 210, 212, 214, picture element 208 will emit light having either the first spectral range 220, the second spectral range 222, or both, that is filtered into, for example, a red component 230, a green component 232, and/or a blue component 234. Since the wide band color filters of the light valves 210, 212, 214 are subtractive, each light component 230, 232, 234 will carry the same frequency (or frequencies) of light produced by emitters 202, 204. An eye of an observer 240 perceives, in combination, each light component 230, 232, 234 through a polarized lens 250 of, for example, passive eyewear. To enhance the 3D effect of the image, polarized lens 250 may be configured to pass light in either the first spectral range 220 or the second spectral range 222. In one example, for eyewear having two lenses (one for each eye), the left lens may be configured to pass light in the first spectral range 220 and the right lens may be configured to pass light in the second spectral range 222. In another example, the right lens may be configured to pass light in the first spectral range 220 and the left lens may be configured to pass light in the second spectral range 222.

FIG. 3 illustrates a schematic diagram of a display device 300 for viewing stereoscopic images in accordance with one embodiment of the present invention. Display device 300 includes an LCD display or other electronically modulated optical device that forms part of a television, computer, or other display device adapted to display images that, in conjunction with eyewear having polarized lenses, produce a stereoscopic effect for a viewer. It should be appreciated that display device 300 may comprise, for example, a thin film transistor liquid crystal display (TFT LCD), an organic light emitting diode (OLED), or other microelectromechanical systems (MEMS) device.

In one embodiment, display device 300 includes a plurality of sequentially addressable picture elements such as picture elements 112 described above with reference to FIG. 1. Display device 300 includes at least one emitter 302, a display device controller 304, a picture element 306, and an optical filter 308. The picture elements, including picture element 306, may be controlled, for example, by a display device controller 304, such as display device controller 108 described above with reference to FIG. 1. Display device 300 may be configured such that light emanating from emitter 302 propagates through optical filter 308, picture element 306, and onward towards the viewer. Emitter 302 may include one or more florescent lamps, one or more light emitting diodes (LEDs), such as white phosphor based LEDs, red-green-blue (RGB) LEDs, organic LEDs (OLEDs), or other electronic light sources. In one embodiment, emitter 302 is arranged in a backlit configuration for illuminating picture element 306 from behind with respect to a viewer of the light emanating from display device 300. In another embodiment, emitter 302 may be configured to illuminate picture element 306 indirectly, such as from a side or edge of the display.

In an embodiment, emitter 302 is configured to emit a substantially wide band of white light 320. Optical filter 308 is configured to filter white light 320 into filtered light 322 that includes either a first spectral range of visible light (e.g., RGB) or a second spectral range of visible light (e.g., R′G′B′) that is distinct from the first spectral range of visible light. Optical filter 308 is controllable by display device controller 304 such that optical filter 308 is switched between filtering light into the first spectral range and the second spectral range in synchronization with an update of picture element 306. Filtered light 322 is transmitted to picture element 306, which includes a plurality of light valves 310, 312, 314. The light valves may include, for example, a wide band color filter for red 310, green 312, and blue light 314. Light valves 310, 312, 314 may be coupled to display device controller 304 for modulating the amount and color of light passing through picture element 306. Accordingly, depending on the modulation of light valves 310, 312, 314, picture element 306 will emit light having either the first spectral range, the second spectral range, or both, that is filtered by the wide band color filters into, for example, a red component 330, a green component 332, and/or a blue component 334. Since the wide band color filters of the light valves 310, 312, 314 are subtractive, each light component 330, 332, 334 will carry the same frequency (or frequencies) of light transmitted by optical filter 308. An eye of an observer 340 perceives, in combination, each light component 330, 332, 334 through a lens 350 of, for example, passive eyewear. To enhance the 3D effect of the image, lens 350 may be configured to pass filtered light 322 in either the first spectral range or the second spectral range. In one example, for eyewear having two lenses (one for each eye), the left lens may be configured to pass light in the first spectral range and the right lens may be configured to pass light in the second spectral range. In another example, the right lens may be configured to pass light in the first spectral range and the left lens may be configured to pass light in the second spectral range.

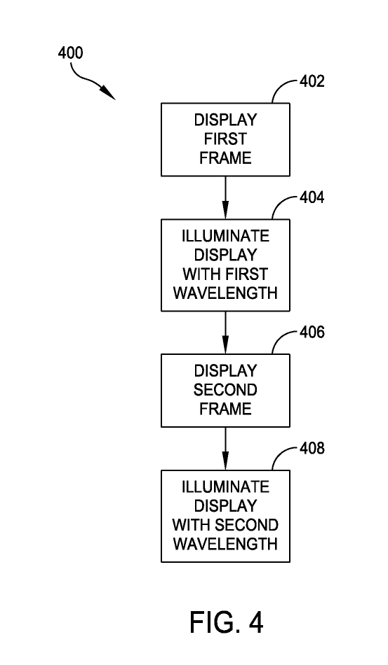

FIG. 4 is a flow diagram illustrating a method of displaying a stereoscopic image 400 according to one embodiment. Method 400 may be implemented by a display device such as display device 100 as described above with reference to FIG. 1, for example, an LCD display having a plurality of sequentially updatable picture elements. The display device is configured to display, for example, a series of frames of a video or movie, where each frame includes a field of view that is designed to be observed by either the viewer's left or right eye. As described above, the viewer wears frequency selective eyewear that steers the displayed frame to the correct eye. Accordingly, by displaying alternating fields of view, the viewer perceives a 3D effect.

To accomplish this, method 400 includes an act of displaying a first frame of the series of frames on the display device (ACT 402). ACT 402 may include updating one of the picture elements with a portion of the first frame, or updating several or all of the picture elements with respective portions of the first frame to produce a partial or full-screen image. Method 400 further includes an act of illuminating one or more of the picture elements with a first spectral range of visible light (ACT 404), for example, RGB, that corresponds to the field of view of the image in the first frame (e.g., a right eye field of view). Consequently, the portion(s) of the first frame that are displayed on the screen are transmitted in the first spectral range, which will be passed by a first lens of the viewer's eyewear and blocked by the second lens, enabling the viewer to see the image with the correct eye.

Method 400 further includes an act of displaying a second frame of the series of frames (ACT 406). Similar to ACT 402, ACT 406 may include updating one or more of the picture elements with a portion(s) of the second frame. Method 400 further includes an act of illuminating one or more of the picture elements with a second spectral range of visible light (ACT 408), for example, R′G′B′, that corresponds to the field of view of the image in the second frame (e.g., a left eye field of view). Consequently, the portion(s) of the second frame that are displayed on the screen are transmitted in the second spectral range, which will be passed by the second lens of the viewer's eyewear and blocked by the first lens.

According to another aspect of the invention, the display device, such as an LCD television or other progressive scan display device, includes a rolling BLU. An LCD television screen is not updated synchronously. Each line of the screen is updated sequentially, for example, column-by-column from left to right and row-by-row from top to bottom, or in another sequence. The update occurs over a non-zero time, usually of the same order as a frame time, for example, about 8 milliseconds for a 120 Hz LCD television. This sequential update means that active eyewear cannot be completely synchronized with the update of the frame. Some portion of the screen (usually the bottom) will be displaying part of the image from the previous eye view. This causes crosstalk between left and right eye and can be very disorienting to a viewer.

One approach to addressing this limitation is to substantially extend the vertical blanking interval of the LCD panel in conjunction with active eyewear. This has the effect of decreasing the time during which the image is sequentially updated, and increasing the time in which the image is held. If the pi-cell in the active eyewear is opened only during the hold time, observation of the update scanning can be eliminated. However, there are limits to the amount by which the hold time can be extended, and the brightness of the observed image is also reduced since the pi-cell needs to be closed for much of the frame time.

In another method, the panel is scanned at a higher rate (e.g., 240 Hz). Each frame is repeated twice, for example, left-left-right-right. The pi-cell in the active eyewear is held open only for the portion of time in which the image is not being changed, which is the second “left” and second “right” described above. Again, this system suffers from brightness loss, and increased cost of 240 Hz panel operation.

Therefore, it is desirable to produce a 3D stereoscopic TV system which avoids the limitations of the prior art, allows the use of passive eyewear, and removes the scanning artifact without reducing the overall brightness of the picture.

According to various embodiments, the display device may include one or more light sources that illuminate all or part of the screen. In one example, the screen may be entirely illuminated with one spectral range of visible light, which enables the viewer wearing frequency selective eyewear to see the entire displayed image with only one eye. In another example, various portions of the screen may be illuminated with different spectral ranges of visible light, which enables the viewer to see certain portions with one eye and other portions with the other eye. Depending on the configuration of the light source, the spectral range of light emitted by any particular picture element may, at any given time, may match the field of view of the portion of the image being displayed by the picture element, or it may not, depending on where the picture element is with respect to the update scan of the display and when the light source is switched between generating one spectral range and another. It is therefore appreciated that a light source configured to illuminate individual picture elements (or relatively small groups of picture elements) enables a greater degree of control over which spectral range of light is being emitted by the respective picture elements at any given time.

According to various embodiments, a BLU may be configured as an area lit (or backlit), or edge-lit device. The emitters of the BLU emit light into a light guide or light plate, which may be a sheet of diffuse plastic with an engineered surface or other material suitable for transmitting light, such as fiber optics or other light conductors. The surface is designed to allow the light to emit from the plate at uniform intensity across a wide area, such as over all of the pixels of an LCD display. Emitters having emission frequencies RGB and R′G′B, respectively, are located at various locations in the BLU such that the light is uniformly distributed across the entire display. When the set of RGB emitters are turned on, the light plate is uniformly lit with RGB-frequency light, and when the set of R′G′B′ emitters are turned on, the light plate is uniformly lit with R′G′B′-frequency light. The location of the emitters and backlight design may be arranged such that clusters of emitters can be lit sequentially so as to produce a scanning backlight. Such a backlight projects a substantially horizontal region of illumination into the light plate. The portion of the light plate thus illuminated may be controlled in horizontal segments.

In one embodiment, edge-lit LEDs are used. The BLU is engineered to substantially project the light from the LED into a horizontal region of the BLU. The LEDs are further controlled such that the LED behind the corresponding portion of the LCD screen that is being updated in, for example, a line-sequential scanning fashion is extinguished. Therefore, the observer will not see any light from the portion of the screen undergoing a update. The sequential control of the horizontal LED segments produces a rolling light source that acts as a shutter, which eliminates crosstalk associated with artifacts caused by sequentially updating the display with alternating left-right fields of view over a non-zero period of time.

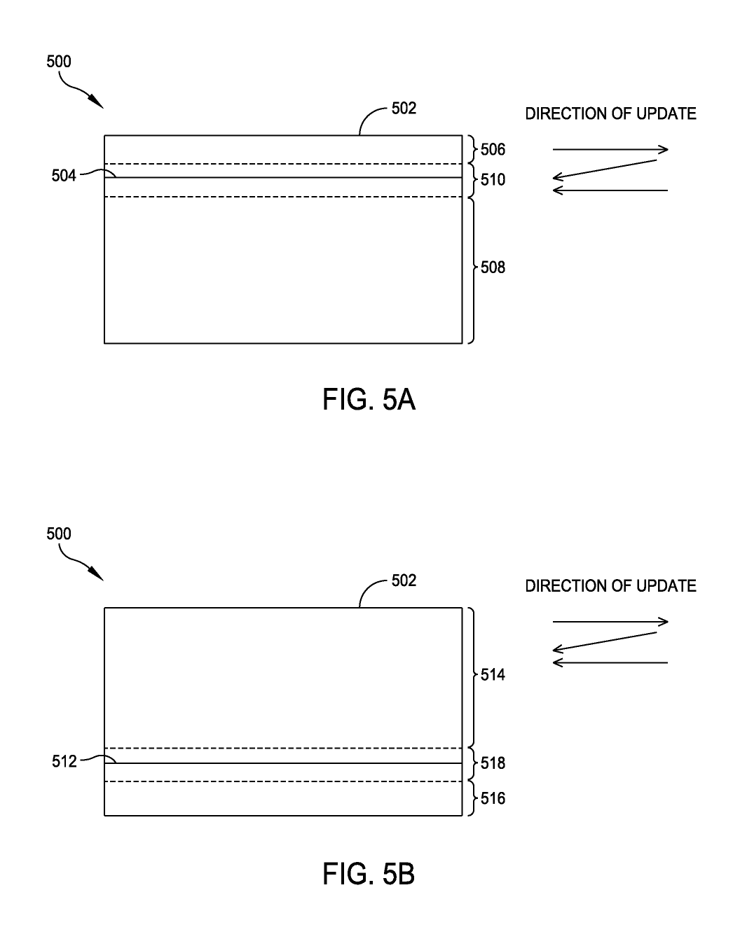

FIGS. 5A and 5B depict a display device 500 for viewing stereoscopic images in accordance with various embodiments. Display device 500 includes an LCD display or other electronically modulated optical device that forms part of a television, computer, or other display device adapted to display images that, in conjunction with passive eyewear having polarized lenses, produce a stereoscopic effect for a viewer.

According to one embodiment, display device 500 includes a display screen 502 having a plurality of picture elements, and a light source. The light source may include one or more florescent lamps, one or more light emitting diodes (LEDs), such as white phosphor based LEDs, red-green-blue (RGB) LEDs, organic LEDs (OLEDs), or other electronic light sources. In one embodiment, the light source is arranged in a backlit configuration for illuminating display screen 502 from behind with respect to a viewer of the light emanating from display device 500. In another embodiment, the light source may be configured to illuminate display screen 502 indirectly, such as from a side or edge of the display screen.

In one embodiment, display screen 502 is a sequentially addressable display screen, for example, a thin film transistor liquid crystal display (TFT LCD), an organic light emitting diode (OLED), or other microelectromechanical systems (MEMS) device. Display screen 502 includes a plurality of sequentially addressable picture elements and may be controlled, for example, by a display device controller, such as display device controller 108 described above with reference to FIG. 1. Display device 500 may be configured such that light emanating from the light source propagates through the picture elements and onward towards the viewer.

Referring to FIG. 5A, display screen 502 includes a plurality of scan lines including a first scan line 504. In one embodiment, display screen 502 is updated sequentially one scan line at a time, for example, from top to bottom, or from bottom to top, or in another sequence. At a given point in time, one or more of the picture elements along first scan line 504 are being updated. The picture elements in first region 506 are illuminated with a first spectral range of visible light (e.g., RGB), and the picture elements in second region 508 are illuminated with a second spectral range of visible light (e.g., R′G′B′), while the picture elements in third region 510, including the picture elements along first scan line 504, are dimmed or obscured from view. The illumination of first and second regions 506, 508 may be provided by one or more clusters of emitters producing the first and second spectral ranges of visible light respectively, such as the emitters described above with reference to FIGS. 2 and 3.

Referring now to FIG. 5B, at a given point in time one or more of the picture elements along second scan line 512 are being updated. The picture elements in fourth region 514 are illuminated with the first spectral range of visible light (e.g., RGB), and the picture elements in fifth region 516 are illuminated with the second spectral range of visible light (e.g., R′G′B′), while the picture elements in sixth region 518, including the picture elements along second scan line 512, are dimmed or obscured from view. The illumination of fourth and fifth regions 514, 516 may be provided by one or more clusters of emitters producing the first and second spectral ranges of visible light respectively, such as the emitters described above with reference to FIGS. 2 and 3. Thus, according to one embodiment, the light source of display device 500 as shown in FIGS. 5A and 5B is implemented as a rolling backlight, wherein at least one region of display 502 being updated is dimmed, while other regions are illuminated with at least one spectral range of visible light.

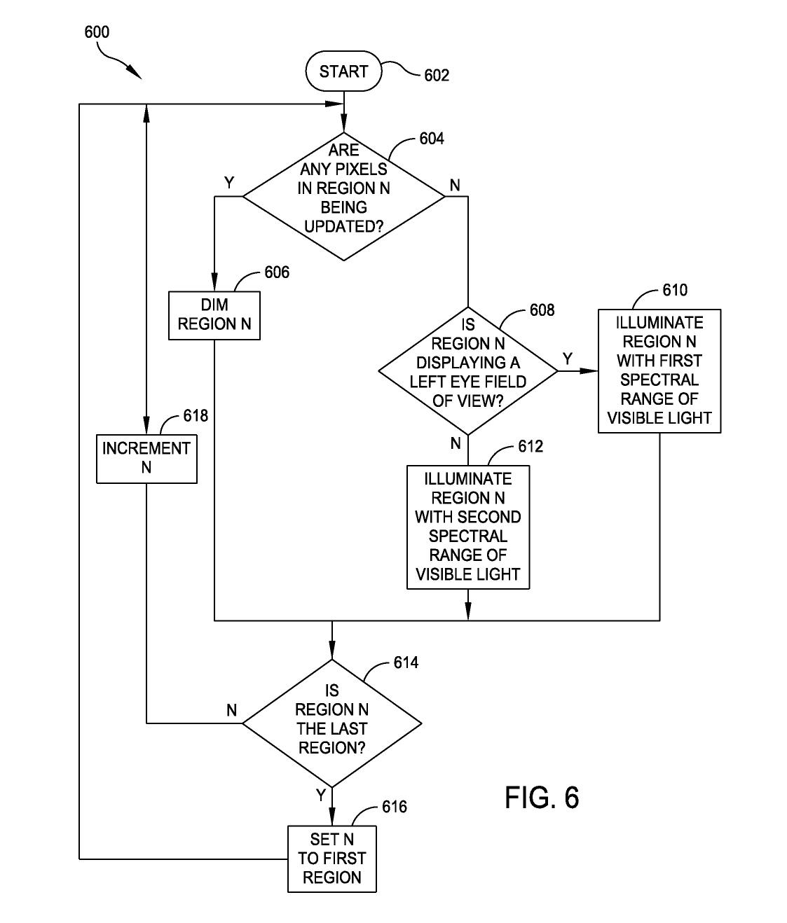

FIG. 6 is a flow chart illustrating a method of displaying a stereoscopic image 600 according to one embodiment. Method 600 may be implemented by a display device having, for example, a plurality of frequency selective light sources, such as LED emitters, each configured to generate at least a first spectral range of visible light (e.g., RGB) and a second spectral range of visible light (e.g., R′G′B′). For example, each light source may generate only RGB, only R′G′B′, or both RGB and R′G′B′ separately and independently. Each of the light sources is configured and arranged to illuminate at least one of a plurality of regions of the display. Each region includes a plurality of picture elements, or pixels, that are sequentially updated, for example, from the top of the display to the bottom, and then again from the top to the bottom in a repeating manner. It will be understood that other sequences are possible and not foreclosed by method 600. The light sources may be controlled by, for example, a display device controller that is coupled to a video source and each of the light sources. The controller enables different regions the display to be illuminated with the correct spectral range of visible light in synchronization with the image provided by the video source. This permits each portion of an image displayed in each region to be steered toward the correct eye of a viewer wearing passive eyewear.

Method 600 begins at block 602, with N set to 1 or any integral value less than or equal to the total number of regions of the display. At block 604, if any pixels within region N are being updated, method 600 proceeds to block 606, where the pixels within region N are dimmed so as to obscure or substantially obscure those pixels from the viewer. Further, at block 604, if none of the pixels within region N is being updated, method 600 proceeds to block 608.

At block 608, if any of the pixels within region N are displaying a portion of an image having a left eye field of view, method 600 proceeds to block 610, where the pixels within region N are illuminated by the corresponding light source(s) with a first spectral range of visible light (e.g., RGB); otherwise, method 600 proceeds to block 612, where the pixels of region N are illuminated by the corresponding light source(s) with a second spectral range of visible light (e.g., R′G′B′). It will be understood that the left eye field of view may be presented with the second spectral range of light and the right field of view may be presented with the first spectral range of light.

At block 612, if region N is the last region of the display, N is set to the first region at block 616, and method 600 returns to block 604. Further, at block 612, if region N is not the last region of the display, N is incremented by one region at block 618, and method 600 returns to block 604. Method 600 may repeat in this manner indefinitely, for example, for the duration of time in which the display is operating.

In one embodiment, if any of the pixels of region N are undergoing an update, those pixels may be illuminated again after the update of all pixels in region N are complete. If the update occurs sufficiently quickly, the extinguishment and re-illumination of the pixels in region N will be imperceptible, or substantially imperceptible, to the viewer. Furthermore, more than one of the regions of the display may be simultaneously, or substantially simultaneously, illuminated using different spectral ranges of light, which enables the respective picture elements to be observed by different eyes of the viewer and maximizes the brightness of the display. This may occur, for example, in a sequentially updated display where the picture element being updated is located, sequentially, between a first region displaying a portion of a current frame of a video and a second region displaying a portion of a previous frame of the video (e.g., mid-scan), such as described above with reference to FIGS. 5A and 5B.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of the invention. It should be appreciated that the video source may be projected in sequences other than an alternating-frame sequence, for example, with left and right fields of view projected simultaneously (or substantially simultaneously), or in a left-left-right-right sequence, or other combination of sequences. Furthermore, other techniques may be used to enhance the 3D effect of the displayed images, such as increasing the update rate of the display (e.g., 240 Hz or 480 Hz) and/or increasing the vertical blanking interval to enable the light source to switch between one spectral range of light and another in between frame updates. Accordingly, the foregoing description and drawings are by way of example only.

What is claimed is:

1. An electronic display device, comprising:
a frequency selective light source configured to generate light including a selected one of a first spectral range of visible light and a second spectral range of visible light that is distinct from the first spectral range of visible light;
a display device having a plurality of sequentially updatable picture elements, at least one of the plurality of sequentially updatable picture elements being optically aligned with the frequency selective light source such that the light generated by the frequency selective light source provides illumination to the at least one of the plurality of sequentially updatable picture elements; and
a display device controller coupled to the frequency selective light source and configured to select, in response to an update of the at least one of the plurality of sequentially updatable picture elements, one of the first spectral range of visible light and the second spectral range of visible light to be provided by the frequency selective light source.

2. The device of claim 1, wherein the frequency selective light source comprises a first LED emitter configured to generate the first spectral range of visible light, and a second LED emitter configured to generate the second spectral range of visible light.

3. The device of claim 2, wherein the first LED emitter includes a first phosphorescent material configured to emit the first spectral range of visible light, and wherein the second LED emitter includes a second phosphorescent material configured to emit the second spectral range of visible light.

4. The device of claim 3, wherein the frequency selective light source comprises a plurality of clusters of emitters, at least one cluster of the plurality of clusters of emitters including the first LED emitter and the second LED emitter, and wherein illumination provided by each of the first LED emitter and the second LED emitter is independently controllable.

5. The device of claim 1, wherein the frequency selective light source comprises a white light LED emitter and an optical filter interposed between the white light LED emitter and the at least one of the plurality of sequentially updatable picture elements, the optical filter configured to filter white light generated by the white light LED emitter into the selected one of the first spectral range of visible light and the second spectral range of visible light.

6. The device of claim 5, wherein the frequency selective light source comprises a plurality of clusters of emitters, at least one of the plurality of clusters of emitters including the white light LED emitter and the optical filter.

7. The device of claim 1, wherein the display device controller is further configured to dim the illumination provided by the frequency selective light source during an update of the at least one of the plurality of sequentially updatable picture elements.

8. The device of claim 1, wherein each of the plurality of sequentially updatable picture elements includes a plurality of light valves for modulating light generated by the frequency selective light source.

9. The device of claim 8, wherein the plurality of light valves includes a red light valve, a green light valve, and a blue light valve.

10. The device of claim 1, wherein the display device is one of a thin film transistor liquid crystal display and an organic light emitting diode display.

11. A method of displaying images with an electronic display device having a plurality of sequentially updatable picture elements, the method comprising acts of:
performing a first update of a first picture element of the plurality of sequentially updatable picture elements to display a portion of a first image frame of a plurality of image frames;
illuminating, responsive to the act of performing the first update of the first picture element, the first picture element with a first spectral range of visible light;
performing a second update of the first picture element to display a portion of a second image frame of the plurality of image frames; and
illuminating, responsive to the act of performing the second update of the first picture element, the first picture element with a second spectral range of visible light that is distinct from the first spectral range of visible light.

12. The method of claim 11, further comprising dimming illumination of the first picture element during an update of the first picture element.

13. The method of claim 12, further comprising illuminating a second picture element of the plurality of sequentially updatable picture elements with one of the first spectral range of visible light and the second spectral range of visible light during the update of the first picture element.

14. The method of claim 11, wherein the act of illuminating the first picture element with the first spectral range of visible light includes energizing a first LED emitter to stimulate emission of the first spectral range of visible light therefrom using a first type of phosphorescent material.

15. The method of claim 14, wherein the act of illuminating the first picture element with the second spectral range of visible light includes energizing a second LED emitter to stimulate emission of the second spectral range of visible light therefrom using a second type of phosphorescent material.

16. The method of claim 11, wherein the act of illuminating the first picture element with the first spectral range of visible light includes energizing a white light LED emitter to stimulate emission of white light therefrom and filtering the white light to produce the first spectral range of visible light using a first filter.

17. The method of claim 16, wherein the act of illuminating the first picture element with the second spectral range of visible light includes energizing the white light LED emitter to stimulate emission of the white light therefrom and filtering the white light to produce the second spectral range of visible light using a second filter.

18. The method of claim 17, wherein the act of illuminating the first picture element with the first spectral range of visible light further includes blocking the second spectral range of visible light with the first filter.

19. The method of claim 18, wherein the act of illuminating the first picture element with the second spectral range of visible light further includes blocking the first spectral range of visible light with the second filter.

20. The method of claim 19, further comprising aligning the first filter with an optical path of the white light responsive to the act of performing the first update of the first picture element, and further comprising aligning the second filter with the optical path of the white light responsive to the act of performing the second update of the first picture element.

21. The method of claim 11, wherein the first spectral range of visible light is obscured by a first lens of a passive eyewear, and wherein the second spectral range of visible light is obscured by a second lens of the passive eyewear.
